(19) United States
(12) Patent Application Publication
(10) Pub. No.: US 2014/0216338 A1
(43) Pub. Date: Aug. 7, 2014

(54) DEVICE FOR PROPERLY APPLYING CONDUCTIVE GLUE ON PHOTOELECTRIC ELEMENT

(71) Applicant: HON HAI PRECISION INDUSTRY CO., LTD., New Taipei (TW)

(72) Inventor: CHIH-CHEN LAI, New Taipei (TW)

(21) Appl. No.: 13/931,766

(22) Filed: Jun. 28, 2013

(30) Foreign Application Priority Data
Feb. 5, 2013 (TW) 102104294

(51) Int. Cl. H01B 13/00

(52) U.S. Cl. CPC H01B 13/00
USPC 118/712

(57) ABSTRACT

A device to apply and confirm the proper dispensation of conductive glue includes a nozzle vacuum-lifting a photoelectric element having a bonding surface, a base defining a receiving recess, a conductive glue received in the recess, a driver, and a controller controlling the driver to drive the nozzle to dip the photoelectric element into the conductive glue. A first camera module positioned on the base and aimed at the bonding surface takes images of the bonding surface. The controller is in communication with the first camera module and processes the images to determine if the amount of conductive glue and the spread area on the bonding surface are correct and, if yes, control the driver to pass on the photoelectric element, or if no, control the driver to reject the photoelectric element.

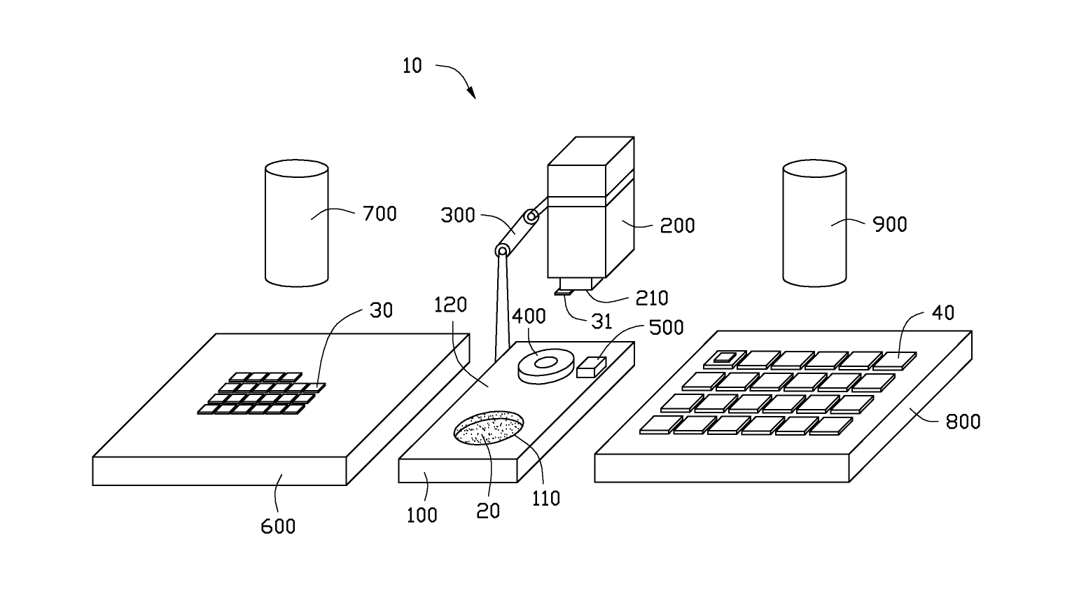

### BACKGROUND

1. Technical Field

The present disclosure relates to optical connectors and more particularly to a device for assembling a photoelectric element onto a substrate.

2. Description of Related Art

Optical connectors include a substrate and a photoelectric element positioned on and electrically connected to the substrate via conductive glue. However, if the conductive glue is excessively or insufficiently applied, bad connections, such as short circuits and open circuits, may be formed between the photoelectric element and the substrate, which cannot be detected during the process of assembly.

Therefore, it is desirable to provide a device for assembling a photoelectric element on a substrate, which can overcome the above-mentioned problems.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure.

The drawing is a schematic view of a device for assembling a photoelectric element onto a substrate, according to an embodiment.

### DETAILED DESCRIPTION

Embodiments of the present disclosure will be described with reference to the drawing.

The drawing shows a device 10 for assembling a photoelectric element 30 onto a substrate 40 via conductive glue 20, according to an embodiment. The photoelectric element 30 can be a light emitting element such as a light emitting diode or a laser diode, or a light detecting element such as a photo diode. The photoelectric element 30 includes a bonding surface 31. The device 10 includes a base 100, a nozzle 200, a driver 300, a first camera module 400, and a controller 500.

The base 100 defines a receiving recess 110 for receiving the conductive glue 20. In detail, the base 100 includes a first surface 120, such as a top surface. The recess 110 is defined in the first surface 120.

The nozzle 200 vacuum-lifts the photoelectric element 30. In detail, the nozzle 200 includes a holding surface 210 onto which the photoelectric element 30 is vacuum-lifted. A hole (not shown) is defined in the holding surface 210 and extends to a vacuum pump (not shown) to enable the evacuation of air. To avoid the photoelectric element 30 be damaged by the nozzle 200 when vacuum-lifting, a buffer layer (not shown) is attached to the holding surface 210.

The driver 300 such as a mechanical arm is mechanically connected to the nozzle 200. The driver 300 drives the nozzle 200 to dip the photoelectric element 30 into the conductive glue 20 such that the conductive glue 20 is applied to the bonding surface 31 under control of the controller 500.

The first camera module 400 is positioned on the base 100 (i.e. the first surface 120) and is aimed at the bonding surface 31. The first camera module 400 takes images of the bonding surface 31.

The controller 500 is in communication with the first camera module 400 and processes the images of the photoelectric element 30 to determine whether or not the conductive glue 20 is properly applied to the bonding surface 31.

In detail, the bonding surface 31 is typically a surface of a metal electrode of the photoelectric element and of a bright white color while the conductive glue 20 is typically nontransparent or of a darker color as compared with the color of the bonding surface 31. As such, the controller 400 can determine a thickness of the conductive glue 20 according to a gray scale level of an image of the bonding surface 31. If the bonding surface 31 is too bright, it indicates that the conductive glue 20 applied on the bonding surface 31 is too thin. If the bonding surface 31 is too dark, it indicates that the conductive glue 20 applied on the bonding surface 31 is too thick and excessive. Otherwise, it indicates that the conductive glue 20 is properly applied to the bonding surface 31.

In addition, the controller 500 also can recognize a contour of the conductive glue 20 and determine a size and positional relationship between the conductive glue 20 and the bonding surface 31. If the spread of the conductive glue 20 is smaller and located within the bonding surface 31, it indicates the conductive glue 20 applied on the bonding surface 31 is insufficient. If the spread of the conductive glue 20 is larger and totally covers the bonding surface 31, it indicates that the conductive glue 20 applied on the bonding surface 31 is excessive. Otherwise, it indicates that the conductive glue 20 is properly applied to the bonding surface 31.

The controller 500 is in communication with the driver 300 and the first camera module 400 by wires or wirelessly and controls the driver 300 to reject the photoelectric element 30 and require reworking thereof if the conductive glue 20 is not appropriately applied to the bonding surface 31, or to pass on the photoelectric element 30 if the conductive glue 20 is properly applied to the bonding surface 31. In this embodiment, the controller 500 is also positioned on the base 100 (i.e., the first surface 120) and is in communication with the first camera module 400 wirelessly.

In practice, the device 10 also includes a first tray 600, a second camera module 700, a second tray 800, and a third camera module 900.

The first tray 600 supports the photoelectric element 30. To increase efficiency, the first tray 600 can be configured to support a number of the photoelectric elements 30, which can be arrayed.

The second camera module 700 is positioned above the first tray 600 and takes images of the photoelectric element 30 on the first tray 600.

The controller 500 is also in communication with the second camera module 700. The controller 500 to processes the images of the photoelectric element 30 to recognize a position of the photoelectric element 30 on the first tray 600 and a shape of the photoelectric element 30. The controller 500 controls the driver 300 to position the nozzle 200 under supervision of the second camera module 700 to accurately position the holding surface 210 on the photoelectric element 30.

The second tray 800 supports the substrate 40. To increase efficiency, the second tray 800 can be configured to support a number of the substrates 40, which can be arrayed.

The third camera module 900 is positioned above the holder 40 and takes images of the substrate 40 on the first tray 600. The third camera module 900 is also configured to process the images of the substrate 40 to recognize a position of the substrate 40 on the second tray 800 and a shape of the substrate 40.

The controller 500 is in communication with the third camera module 900. The controller 500 processes the images of the substrate 40 to recognize a position of the substrate 40 on the second tray 800 and a shape of the substrate 40. The controller 500 also controls the driver 300 to position the nozzle 200 under supervision of the third camera module 900 to accurately position the photoelectric element 30 on the substrate 40.

The first cameral module 400, the second camera module 700, and the third camera module 900 can be charge-coupled devices (CCD) or complementary metal-oxide semiconductor (CMOS) devices.

Under the supervision of the first camera module 400, the second camera module 700 and the third camera module 900, precision assembly of the photoelectric element 30 onto the substrate 40 is enhanced.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. A device, comprising:
a nozzle configured for vacuum-lifting a photoelectric element having a boding surface;
a base defining a receiving recess;
a conductive glue received in the receiving recess;
a driver;
a controller configured to control the driver to drive the nozzle to dip the photoelectric element into the conductive glue such that the conductive glue is applied to the bonding surface; and
a first camera module positioned on the base and aiming at the bonding surface and configured to take a plurality of images of the bonding surface;
wherein the controller is in communication with the first camera module and configured to process the image to determine if the conductive glue is appropriately applied to the bonding surface, if the conductive glue is not appropriately applied to the bonding surface, the controller controls the driver to reject the photoelectric element, if the conductive glue is appropriately applied to the bonding surface, the controller controls the driver to pass on the photoelectric element.

2. The device of claim 1, comprising:
a first tray for supporting the photoelectric element; and
a second camera module positioned above the first tray and configured to take a plurality of images of the photoelectric element on the first tray, the second camera module being configured to process the images to recognize a position of the photoelectric element on the first tray and a shape of the photoelectric element;
wherein the driver is in communication to the second camera module, the driver is configured for driving the nozzle to move under supervision of the second camera module to accurately position a holding surface of the nozzle on the photoelectric element.

3. The device of claim 2, wherein the first tray is configured to support a plurality of the photoelectric elements.

4. The device of claim 3, wherein the photoelectric elements are arrayed on the first tray.

5. The device of claim 1, wherein the driver is a mechanical arm.

6. The device of claim 1, comprising:
a second tray configured for supporting the substrate; and
a third camera module positioned above the second tray and configured to take images of the substrate on the second tray, the third camera module being configured to process the image to recognize a position of the substrate on the second tray and a shape of the substrate;
wherein the driver is in communication with to the third camera module and further configured for driving the nozzle to move under supervision of the second camera module to position the photoelectric element on the substrate.

7. The device of claim 6, wherein the second tray is configured to support a plurality of the substrates.

8. The device of claim 7, wherein the substrates are arrayed on the second tray.
